(19) United States
(12) Patent Application Publication
(10) Pub. No.: US 2018/0238763 A1
(43) Pub. Date: Aug. 23, 2018

(54) Field Calibration Verification Tool for A Shunt Type Tension Meter

(71) Applicant: Thomas Hedberg, Frazer, PA (US)

(72) Inventor: Thomas Hedberg, Frazer, PA (US)

(21) Appl. No.: 15/900,785

(22) Filed: Feb. 20, 2018

Related U.S. Application Data
(60) Provisional application No. 62/461,087, filed on Feb. 20, 2017.

(51) Int. Cl. G01L 25/00

(52) U.S. Cl. CPC G01L 25/00; G01L 5/04

(57) ABSTRACT

A field calibration verification tool for a shunt type tension meter has a central body and at least one calibration portion connected to the central body. Each calibrating portion has a tapered portion and a measuring portion. The measuring portion has a specified calibration dimension corresponding to a specific calibration value obtained in a calibration lab. The calibrating portion is inserted into a tension meter up to the measuring portion, which produces a dial reading on the tension meter, which may then be compared to the specific calibration value.

The current application claims a priority to the U.S. Provisional Patent application Ser. No. 62/461,087 filed on Feb. 20, 2017.

### FIELD OF THE INVENTION

The present invention relates generally to calibration tools. More particularly, the present invention is a tool for performing field calibration values on a shunt type tension meter.

### BACKGROUND OF THE INVENTION

A tension meter is a device used to measure tension in wires, cables, textiles, belts and more. The Penn-Tech Cable Tension Meter is a precision instrument that accurately measures cable tension while suspended on the cable line with hooks, providing an accurate reading in a minimal amount of time without the need to disturb cable anchor points. Tension is measured by reading deflection of the cable, eliminating chances of shock load to supporting hardware or structures.

It is important in many applications for cables to be maintained within a specified tension range in order to ensure reliability of the cable and structures supported by the cable. Therefore, routine checks should be made to verify that the cable is properly tensioned. It is important that the tool used to measure the tension of the cable is accurate. In the field or through general use or transportation, a tension meter may be dropped, struck by an object, or other events may occur to cause the tension meter to become uncalibrated, resulting in inaccurate readings. Therefore, it is important to verify that the tension meter is providing accurate readings in the field before taking a tension measurement of a cable.

### BRIEF DESCRIPTION OF THE DRAWINGS

FIG. 1 is a perspective view of an embodiment of the present invention.

FIG. 2 is a side view of an embodiment of the present invention.

FIG. 3 is a side view illustrating exemplary dimensions of an embodiment of the present invention

FIG. 4 is a top view of an embodiment of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

The present invention is designed to test a Penn-Tech shunt type tension meter prior to use in the field and any time the meter has had impacted by being dropped, hit by object, or other events that may impact the accuracy reading of the tension meter. The present invention is used to verify that the dial of the tension meter is properly functioning, and readings are accurate compared to the calibrated readings recorded during the last manufacturer calibration.

The present invention may be tested in a calibration lab and readings recorded on a calibration certificate. When testing in the field, measurements taken with the present invention should be within a specified margin of the manufacturer recorded readings. If this is not achieved, the tension meter may have to be sent to the manufacturer and repaired or re-calibrated. Before deciding to send in the unit, the user should inspect for loose hardware, dirt, mud or object lodged in the movable parts of the handle and dial areas.

In general, the present invention is simple to use, preferably having two positions for test readings labeled 1 & 2 on each end. Each of the two ends will provide a dial reading that is to be compared to the calibration readings recorded on the calibration certificate. The verification readings are determined by inserting each end of the tool between the cut in the tension meter body at the dial location end.

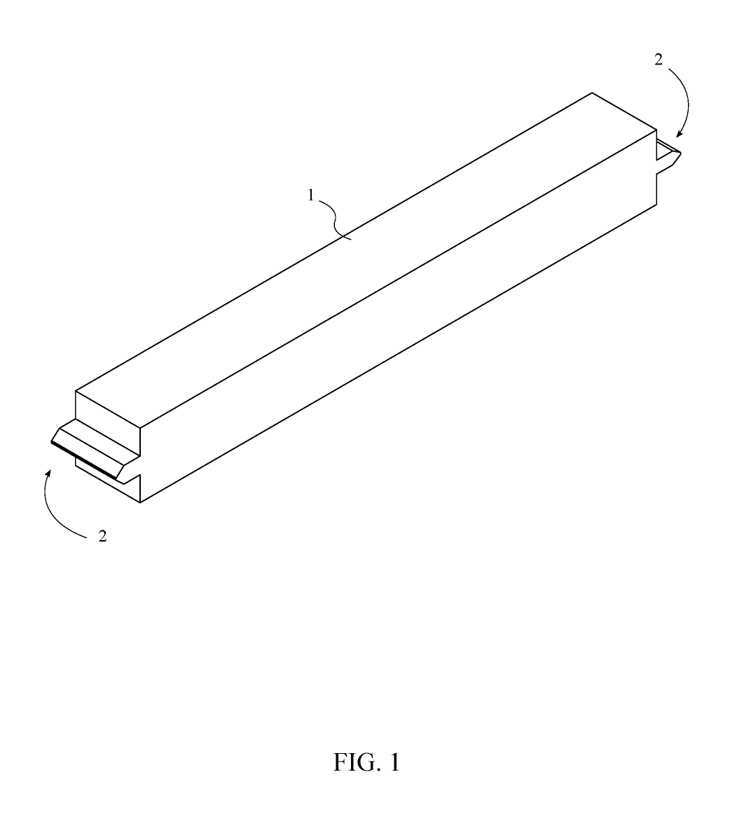

More particularly, referring to FIG. 1, the present invention comprises a central body 1 and at least one calibrating portion 2. The central body 1 occupies the majority of the physical space of the present invention and is the primary point of contact through which the user holds and manipulates the present invention. In some embodiments, the central body 1 may be shaped as a rectangular prism. Preferably, the central body 1 is elongated between a first end and a second end to form a generally rod-like shape in order to enable the user to adequately grip and manipulate the present invention. In other embodiments, the central body 1 may comprise other general shapes or cross sections, such as, but not limited to, rounded. In some embodiments, the central body 1 measures 4 inches in length and ½ inch in width.

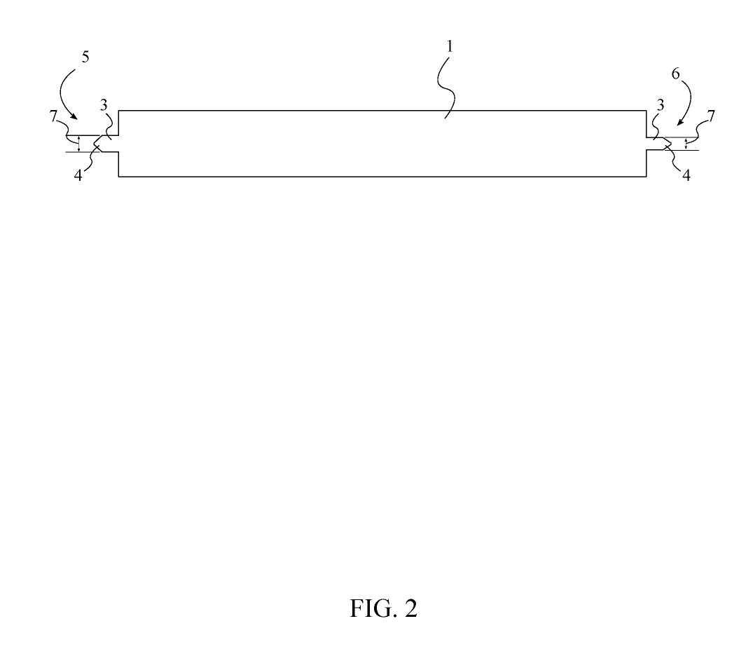

In the preferred embodiment of the present invention, in reference to FIG. 2, each of the at least one calibrating portion 2 is mounted onto the central body 1, and each of the at least one calibrating portion 2 comprises a measuring portion 3 and a tapered portion 4. The measuring portion 3 is connected adjacent to the central body 1 for each of the at least one calibrating portion 2, and the tapered portion 4 is connected to the measuring portion 3 opposite the central body 1. The calibrating portion is inserted into an appropriate measuring location on the tool by the tapered portion 4, which opens the measuring location to the specified calibration dimension 7 of the measuring portion 3 of the calibrating portion. For each of the at least one calibrating portion 2, the measuring portion 3 is configured with a specified calibration dimension 7 that corresponds to a specific calibration value for the shunt type tension meter. In order to use the present invention, the user will further possess documentation of each specified calibration value. The user inserts one of the calibrating portions into the tension meter and compares the reading on the dial of the tension meter to the specified calibration value. If the reading from the tension meter does not match the specified calibration value, the user knows that the tension meter is out of calibration and is not reliable to perform measurements.

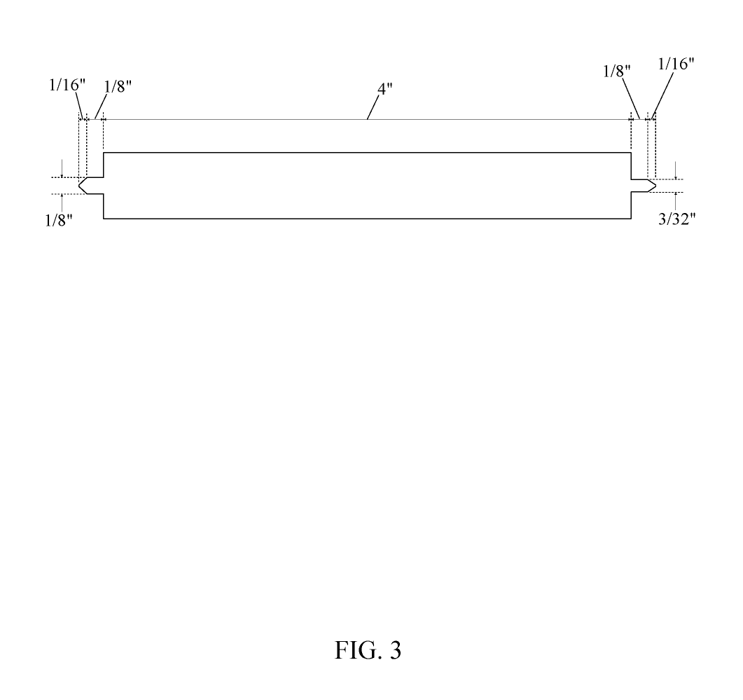

The at least one calibrating portion 2 is manufactured according to specific dimensions and is inserted into the user's tension meter in order to verify accuracy of the meter. In some embodiments, the tapered portion 4 is 1/16 inch in length, and the measuring portion 3 is ⅛ inch in length, though said dimensions may vary in different embodiments. In some embodiments, the tapered portion 4 and the measuring portion 3 may each measure 3/32 inches in length. Preferably, the entirety of the present invention is manufactured as a solid piece from metal such as, but not limited to, 304 stainless steel, though the manufacturing processes and materials utilized may vary in different embodiments. FIG. 3 illustrates various dimensions of the present invention in one exemplary embodiment.

In various embodiments, the quantity of the at least one calibrating portion 2 present may vary. However, in the preferred embodiment of the present invention, the at least one calibrating portion 2 comprises a first calibrating portion 5 and a second calibrating portion 6. Preferably, the first calibrating portion 5 and the second calibrating portion 6 are positioned opposite each other along the central body 1, though it is contemplated that the specific positions of the first calibrating portion 5 and the second calibrating portion 6 may vary, so long as the first calibrating portion 5 and the second calibrating portion 6 are positioned appropriately for use as intended. In some embodiments, the structure of the central body 1 may vary according to the number of calibrating portions present. For example, in an embodiment with three calibrating portions, the central body 1 may be generally triangular in shape, with one of the calibrating portions at each of the vertices of the central body 1.

In general, it is desired to have at least two calibrating portions with different calibration dimensions in order to adequately verify calibration of the tension meter by taking two separate measurements. Thus, in the preferred embodiment, the specified calibration dimension 7 of the first calibrating portion 5 corresponds to a first specific calibration value, and the specified calibration dimension 7 of the second calibrating portion 6 corresponds to a second specific calibration value, wherein the first specific calibration value and the second specific calibration value are different.

For example, in one embodiment, the specified calibration dimension 7 of the first calibrating portion 5 is ⅛ inches, while the specified calibration dimension 7 of the second calibrating portion 6 is 3/32 inches. In another embodiment, the specified calibration dimension 7 of the first calibrating portion 5 is 5/32 inches, while the specified calibration dimension 7 of the second calibrating portion 6 is 9/64 inches. The specified calibration dimension 7 may be understood to be a height of the measuring portion 3, wherein the first calibrating portion 5 and the second calibrating portion 6 are positioned opposite each other along the length of the central body 1 in the preferred embodiment.

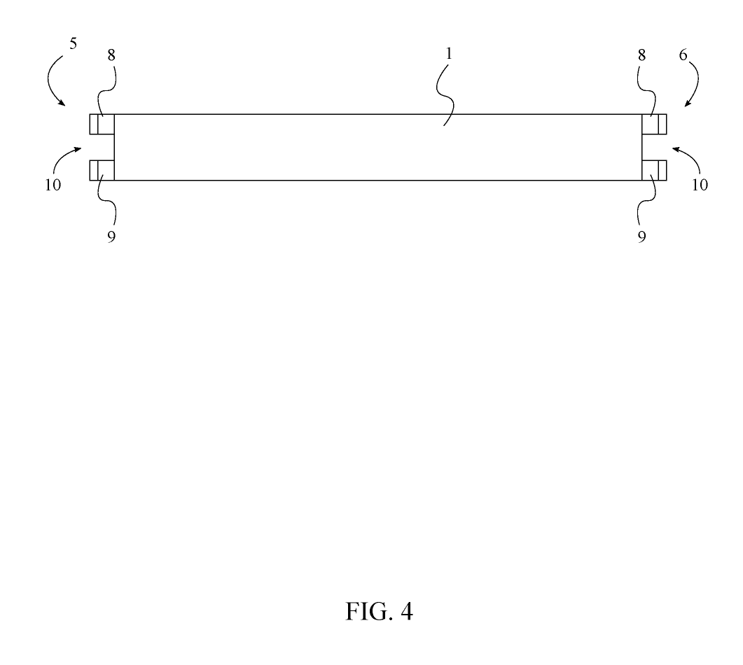

Referring to FIG. 4, in some embodiments, each of the at least one calibrating portion 2 comprises a first prong 8, a second prong 9, and a gap 10. In such embodiments, the gap 10 exists to accommodate a protrusion present in the measurement location of certain models of the tension meter. Thus, the first prong 8 and the second prong 9 are connected adjacent to the central body 1, oriented parallel to each other, and positioned offset from each other by the gap 10, which laterally bisects the calibrating portion, wherein the lateral dimension corresponds to the width of the calibrating portion. In some embodiments, the gap 10 is ¼ inch wide, though the width of the gap 10 may vary in other embodiments.

To use the present invention, the tension meter should be laid on a flat surface. The user inserts the first calibrating portion 5 into the tension meter while the tension meter is laying on a flat surface and records the dial reading. After recording the reading, the user turns the present invention 180 degrees, inserts the second calibrating portion 6, and records the dial reading.

Although the invention has been explained in relation to its preferred embodiment, it is to be understood that many other possible modifications and variations can be made without departing from the spirit and scope of the invention as hereinafter claimed.

What is claimed is:

1. A field calibration verification tool for a shunt type tension meter comprises:
a central body;
at least one calibrating portion;
each of the at least one calibrating portion being mounted onto the central body;
each of the at least one calibrating portion comprises a measuring portion and a tapered portion;
the measuring portion being connected adjacent to the central body for each of the at least one calibrating portion;
the tapered portion being connected to the measuring portion opposite the central body; and
the measuring portion being configured with a specified calibration dimension, wherein the specified calibration dimension corresponds to a specific calibration value for a shunt type tension meter.

2. The field calibration verification tool for a shunt type tension meter as claimed in claim 1 comprises:
the central body being shaped as a rectangular prism.

3. The field calibration verification tool for a shunt type tension meter as claimed in claim 1 comprises:
the at least one calibrating portion comprises a first calibrating portion and a second calibrating portion; and
the first calibrating portion and the second calibrating portion being positioned opposite each other along the central body.

4. The field calibration verification tool for a shunt type tension meter as claimed in claim 3 comprises:
the specified calibration dimension of the first calibrating portion corresponding to a first specific calibration value; and
the specified calibration dimension of the second calibrating portion corresponding to a second specific calibration value.

5. The field calibration verification tool for a shunt type tension meter as claimed in claim 1 comprises:
each of the at least one calibrating portion comprises a first prong, a second prong, and a gap;
the first prong and the second prong being connected adjacent to the central body;
the first prong and the second prong being oriented parallel to each other; and
the first prong and the second prong being positioned offset from each other by the gap.

6. A field calibration verification tool for a shunt type tension meter comprises:
a central body;
at least one calibrating portion;
each of the at least one calibrating portion being mounted onto the central body;
each of the at least one calibrating portion comprises a measuring portion and a tapered portion;
the measuring portion being connected adjacent to the central body for each of the at least one calibrating portion;
the tapered portion being connected to the measuring portion opposite the central body;
the measuring portion being configured with a specified calibration dimension, wherein the specified calibration dimension corresponds to a specific calibration value for a shunt type tension meter;
the at least one calibrating portion comprises a first calibrating portion and a second calibrating portion; and
the first calibrating portion and the second calibrating portion being positioned opposite each other along the central body.

7. The field calibration verification tool for a shunt type tension meter as claimed in claim 6 comprises:
the central body being shaped as a rectangular prism.

8. The field calibration verification tool for a shunt type tension meter as claimed in claim 6 comprises:
the specified calibration dimension of the first calibrating portion corresponding to a first specific calibration value; and
the specified calibration dimension of the second calibrating portion corresponding to a second specific calibration value.

9. The field calibration verification tool for a shunt type tension meter as claimed in claim 6 comprises:
each of the at least one calibrating portion comprises a first prong, a second prong, and a gap;
the first prong and the second prong being connected adjacent to the central body;
the first prong and the second prong being oriented parallel to each other; and
the first prong and the second prong being positioned offset from each other by the gap.

10. A field calibration verification tool for a shunt type tension meter comprises:
a central body;
at least one calibrating portion;
each of the at least one calibrating portion being mounted onto the central body;
each of the at least one calibrating portion comprises a measuring portion and a tapered portion;
the measuring portion being connected adjacent to the central body for each of the at least one calibrating portion;
the tapered portion being connected to the measuring portion opposite the central body;
the measuring portion being configured with a specified calibration dimension, wherein the specified calibration dimension corresponds to a specific calibration value for a shunt type tension meter;
the at least one calibrating portion comprises a first calibrating portion and a second calibrating portion;
the first calibrating portion and the second calibrating portion being positioned opposite each other along the central body;
the specified calibration dimension of the first calibrating portion corresponding to a first specific calibration value; and
the specified calibration dimension of the second calibrating portion corresponding to a second specific calibration value.

11. The field calibration verification tool for a shunt type tension meter as claimed in claim 10 comprises:
the central body being shaped as a rectangular prism.

12. The field calibration verification tool for a shunt type tension meter as claimed in claim 10 comprises:
each of the at least one calibrating portion comprises a first prong, a second prong, and a gap;
the first prong and the second prong being connected adjacent to the central body;
the first prong and the second prong being oriented parallel to each other; and
the first prong and the second prong being positioned offset from each other by the gap.
